(19) United States
(12) Patent Application Publication
(10) Pub. No.: US 2024/0088481 A1
(43) Pub. Date: Mar. 14, 2024

(54) COOLING STRUCTURE OF BATTERY PACK

(71) Applicant: SUBARU CORPORATION, Tokyo (JP)

(72) Inventors: Tatsuya ISHIKAWA, Tokyo (JP); Toshiaki NARUKE, Tokyo (JP)

(21) Appl. No.: 18/233,462

(22) Filed: Aug. 14, 2023

(30) Foreign Application Priority Data
Sep. 12, 2022 (JP) 2022-144718

(51) Int. Cl. H01M 10/6563; H01M 10/613; H01M 10/625

(52) U.S. Cl. CPC H01M 10/6563; H01M 10/613; H01M 10/625

(57) ABSTRACT

A cooling structure of a battery pack includes a battery case, an intake duct, and an intake port. The battery case houses a battery module and electronic equipment coupled to the battery module. The intake duct communicates with the battery case and is configured to send cooling air for cooling the battery module. The intake port is disposed in a top plate of the battery case and is configured to send the cooling air into the battery case. The intake duct is coupled to the top plate so as to communicate with the battery case via the intake port and extends from the intake port to an end of the top plate. The intake duct is provided with a bent part that is downwardly bent in a vicinity of the end of the top plate.

### CROSS-REFERENCE TO RELATED APPLICATIONS

The present application claims priority from Japanese Patent Application No. 2022-144718 filed on Sep. 12, 2022, the entire contents of which are hereby incorporated by reference.

### BACKGROUND

The disclosure relates to a cooling structure of a battery pack.

Existing cooling structures of battery packs include a structure disclosed in Japanese Unexamined Patent Application Publication (JP-A) No. 2019-33055, for example.

A battery pack mainly includes a battery assembly, an air passage member that is disposed on each of an upper surface and a lower surface of the battery assembly, and a sealing member that is interposed between the battery assembly and the air passage member. The battery assembly includes cells that are arranged at predetermined intervals, and for example, it is configured with battery packs. The battery packs are fixed to be disposed in a battery case. A pair of openings through which cooling air passes are provided at ends in an up-down direction of the battery case.

The air passage member is disposed so as to cover the opening of the battery case. The air passage member has a connection port and a duct that is used as an air passage. The air passage member communicates with another air passage member and so on via the connection port. For example, the upper air passage member is used to supply cooling air, whereas the lower air passage member is used to discharge the cooling air. Under these conditions, cooling air passes through gaps between the cells of the battery assembly to cool each of the cells of the battery assembly.

### SUMMARY

An aspect of the disclosure provides a cooling structure of a battery pack including a battery case, an intake duct, and an intake port. The battery case houses a battery module and electronic equipment coupled to the battery module. The intake duct communicates with the battery case and is configured to send cooling air for cooling the battery module. The intake port is disposed in a top plate of the battery case and is configured to send the cooling air into the battery case. The intake duct is coupled to the top plate so as to communicate with the battery case via the intake port and extends from the intake port to an end of the top plate. The intake duct is provided with a bent part that is downwardly bent in a vicinity of the end of the top plate.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view of a vehicle mounted with a cooling structure of a battery pack of an embodiment of the disclosure.

FIG. 2 is a schematic view of the cooling structure of the battery pack of the embodiment of the disclosure.

FIG. 3A is a side view of the cooling structure of the battery pack of the embodiment of the disclosure.

FIG. 3B is a side view of the cooling structure of the battery pack of the embodiment of the disclosure.

FIG. 4 is a schematic view of a cooling structure of a battery pack of another embodiment of the disclosure.

FIG. 5A is a side view of the cooling structure of the battery pack of the another embodiment of the disclosure.

FIG. 5B is a side view of the cooling structure of the battery pack of the another embodiment of the disclosure.

### DETAILED DESCRIPTION

In the cooling structure of the battery pack disclosed in JP-A No. 2019-33055, the pair of openings are disposed in the up-down direction of the battery case and have such a size as to expose upper and lower end surfaces of each cell of the battery assembly. Cooling air that is sent from the upper air passage member is uniformly supplied to each cell in the battery case via the opening. With this structure, in the battery assembly, each cell is evenly cooled, whereby deterioration in battery performance and damage to the cells due to being excessively partially heated are prevented.

Herein, it is assumed that this cooling structure of the battery pack is disposed on a lower surface of a rear floor of a vehicle and that a collision accident occurs from a rear side of the vehicle. The collision accident may damage a rear bumper and a rear beam of the vehicle, and they may invade the inside of the vehicle. Then, the rear bumper and other members crash into the upper air passage member to separate the upper air passage member from the battery case. As a result, an electrode and so on of each cell of the battery assembly are exposed at the opening of the battery case.

That is, electrodes, bus bars, etc., of the battery assembly, which are components of a high-voltage unit in the battery case, are exposed, whereby a possibility for occupants in the vehicle and rescuers to touch the electrodes and other components is increased.

It is desirable to provide a cooling structure of a battery pack, in which a high-voltage unit including battery modules and electronic equipment is hardly exposed at an intake port of a top plate of a battery case when a vehicle accident occurs.

Hereinafter, a cooling structure 10 of a battery pack 11 according to an embodiment of the disclosure will be described in detail based on the drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. The front-rear direction illustrated on the paper represents a longitudinal width direction of the battery pack 11, the right-left direction illustrated on the paper represents a lateral width direction of the battery pack 11, and the up-down direction illustrated on the paper represents a height direction of the battery pack 11.

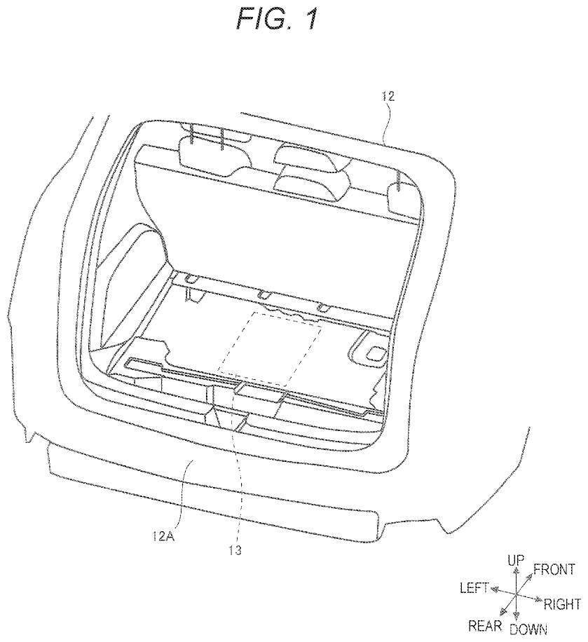

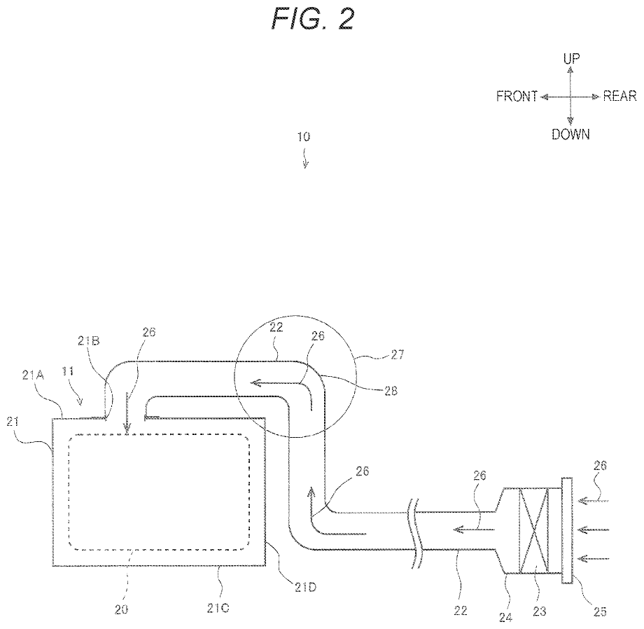

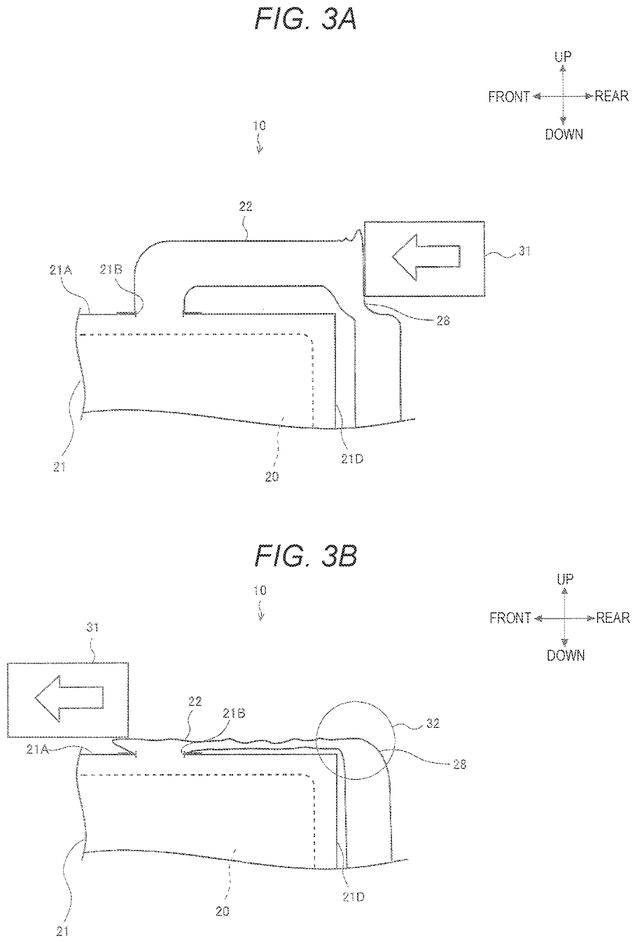

FIG. 1 is a perspective view of a vehicle 12 mounted with the cooling structure 10 of the battery pack 11 of this embodiment. FIG. 2 is a schematic view of the cooling structure 10 of the battery pack 11 of this embodiment. FIGS. 3A and 3B are side views of an intake duct 22 of the cooling structure 10 of the battery pack 11 of this embodiment at the time of being crashed by a barrier 31.

As illustrated in FIG. 1, the vehicle 12, which is an automobile, a train, or the like, is mounted with the battery pack 11 (refer to FIG. 2) for supplying power to a motor and various electric components. For automobiles that can be used as the vehicle 12, electrical vehicles (EVs), hybrid electrical vehicles (HEVs), plug-in hybrid electrical vehicles (PHEVs), and so on, have been spread in recent years.

The battery pack 11 is placed in, for example, a housing space 13 under a rear floor on a rear side of the vehicle 12. A rear bumper 12A and other components of the vehicle 12 are disposed on a rear side of the housing space 13. The placement position of the battery pack 11 is not limited to the housing space 13 under the rear floor and may be a housing space such as under a front floor on which a driver's seat and a passenger seat of the vehicle 12 are placed.

As illustrated in FIG. 2, the battery pack 11 mainly includes battery modules 20, a battery case 21 for housing the battery modules 20, and electronic equipment such as a battery control unit (BCU) for controlling the battery modules 20 and a junction box. In the following description, electronic equipment such as the battery modules 20, the BCU, and the junction box corresponds to a high-voltage unit that is housed in the battery case 21. FIG. 2 omits illustrations of the electronic equipment such as the BCU and the junction box, which is housed in the battery case 21.

The cooling structure 10 of the battery pack 11 mainly includes a battery pack 11, an intake duct 22 for sending cooling air, a blower 23 for pressure-feeding cooling air to the intake duct 22, a blower box 24 that fixes the blower 23 to the intake duct 22, and a dust filter 25.

As illustrated in the drawing, an intake port 21B for sending cooling air into the battery case 21 is disposed in a top plate 21A of the battery case 21. The intake duct 22 is fixed on an upper surface of the top plate 21A by using screws or the like, so as to communicate with the battery case 21 via the intake port 21B. On the other hand, the blower box 24 that houses the blower 23 is disposed upstream of the intake duct 22. The dust filter 25 is disposed at an air inlet of the blower box 24. The blower 23 may be disposed in the intake duct 22 without using the blower box 24. In this case, the dust filter 25 is disposed at an upstream end of the intake duct 22.

As indicated by arrows 26, the blower 23 is, for example, an axial blower, and it pressure-feeds air in a vehicle cabin to the intake duct 22. Air that flows in the intake duct 22 is supplied to the inside of the battery case 21 via the intake port 21B of the battery case 21. This air is, for example, air that is cooled by air conditioning equipment in the vehicle cabin and outside air. This air is sent to the high-voltage unit, such as the battery modules 20, and it is used as cooling air.

The dust filter 25 is a member for collecting foreign matters such as dust, which are contained in the air in the vehicle cabin, and the like. Due to disposing the dust filter 25 at the air inlet of the blower box 24, after a certain amount of foreign matters contained in the air are removed, the air is pressure-fed into the intake duct 22 to be used as cooling air.

As indicated by a circle 27, the intake duct 22 is provided with a bent part 28. The intake duct 22 is coupled to the top plate 21A around the intake port 21B of the battery case 21 and straightly extends to an end of the top plate 21A along the top plate 21A. The bent part 28 of the intake duct 22 is bent at approximately a right angle toward a bottom plate 21C of the battery case 21, in the vicinity of the end of the top plate 21A. That is, the intake duct 22 has an approximately L shape along an outer circumferential surface of the battery case 21, around the battery case 21.

In an exemplary case in FIG. 3A, when pole impact occurs due to a pole colliding from a center part on a rear side of the vehicle 12, a large impact is locally applied to the vehicle 12, and a part of the vehicle 12, such as the rear bumper 12A (refer to FIG. 1), advances toward the housing space 13 under the rear floor of the vehicle 12. The following describes a member such as the rear bumper 12A, which invades the inside of the vehicle 12 at the time of collision of the vehicle 12, as a barrier 31.

As illustrated in the drawing, when the barrier 31 that invades the inside of the vehicle 12 passes over the upper surface of the top plate 21A of the battery case 21, the barrier 31 crashes into the bent part 28 and its surrounding part of the intake duct 22. The intake duct 22 is, for example, a resin component, which is made of a material softer than that of the barrier 31. Thus, it is difficult to prevent the barrier 31 from invading, by using rigidity of the intake duct 22. As a result, the intake duct 22 that is crashed by the barrier 31 is deformed by impact of crash, and the barrier 31 continues advancing toward the upper side of the top plate 21A.

FIG. 3B illustrates a situation in which the barrier 31 continues advancing toward the inside of the vehicle 12 while deforming the intake duct 22 that is disposed above the top plate 21A. The intake duct 22 is crushed by the barrier 31 to be pushed into a space between the top plate 21A and the barrier 31.

As described above, the intake duct 22 is provided with the bent part 28 in the vicinity of the end of the top plate 21A of the battery case 21. The intake duct 22 extends from the bent part 28 toward the bottom plate 21C of the battery case 21 along a side plate 21D of the battery case 21. As indicated by a circle 32, the deformed intake duct 22 is partially hung on the end of the battery case 21. As a result, the intake duct 22 is prevented from advancing toward the inside of the vehicle 12 together with the barrier 31 and remains coupled to the top plate 21A of the battery case 21.

With this structure, the barrier 31 further advances to the inside of the vehicle 12, whereas the intake port 21B of the top plate 21A of the battery case 21 remains covered with the intake duct 22. Although disposed in the vicinity of the intake port 21B in the battery case 21, the high-voltage unit, such as the electrodes of the battery modules 20 and the bus bar, is prevented from being exposed at the intake port 21B. Thus, the possibility for occupants in the vehicle and rescuers to touch the high-voltage unit is reduced.

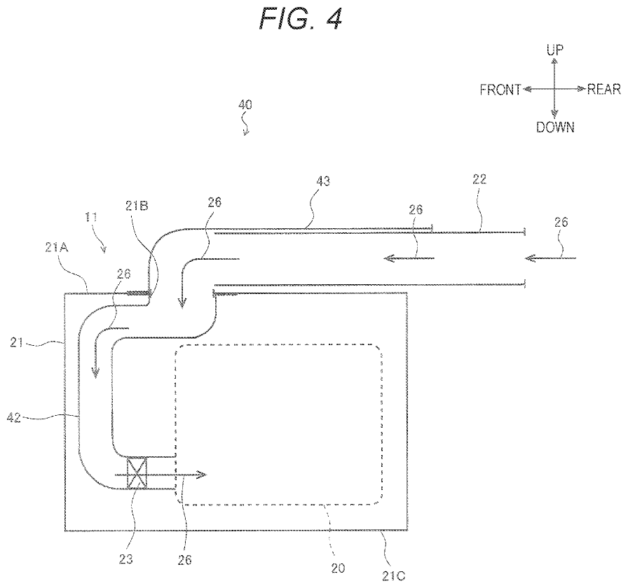

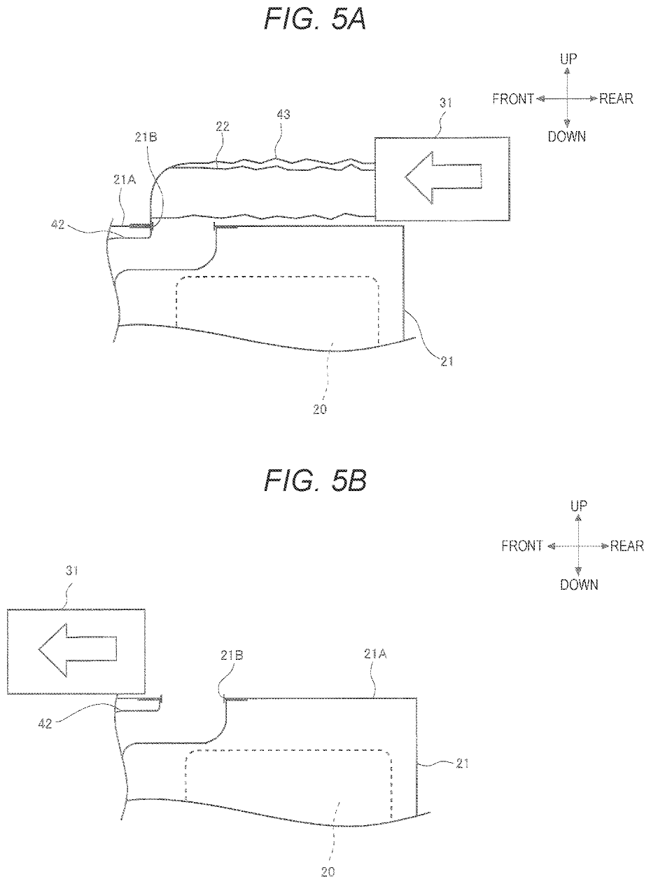

Next, a cooling structure 40 of a battery pack 11 according to another embodiment of the disclosure will be described in detail based on FIGS. 4 to 5B. It is noted that this embodiment is basically described by using the same reference numerals for the members that are the same as those in the cooling structure 10 of the battery pack 11, which are described with reference to FIGS. 1 to 3B, and repeated description is omitted. The front-rear direction illustrated on the paper represents a longitudinal width direction of the battery pack 11, the right-left direction illustrated on the paper represents a lateral width direction of the battery pack 11, and the up-down direction illustrated on the paper represents a height direction of the battery pack 11.

FIG. 4 is a schematic view of the cooling structure 40 of the battery pack 11 of this embodiment. FIGS. 5A and 5B are side views of an intake duct 22 and a duct fixing part 43 of the cooling structure 40 of the battery pack 11 of this embodiment at the time of being crashed by a barrier 31.

As illustrated in FIG. 4, in the cooling structure 40 of the battery pack 11, electronic equipment such as battery modules 20, a BCU for controlling the battery modules 20, and a junction box, is disposed in a battery case 21. The cooling structure 40 of this embodiment differs from the cooling structure 10 in that an inner duct 42 is provided in the battery case 21. The inner duct 42 is fixed on a lower surface of the top plate 21A by using screws or the like, so as to communicate with the intake duct 22 via an intake port 21B.

The cooling structure 40 of the battery pack 11 mainly includes a battery pack 11, an intake duct 22 for sending cooling air, a blower 23 for sucking cooling air to the intake duct 22, and an inner duct 42 disposed in the battery case 21. Although not illustrated, a dust filter 25 may be disposed at an upstream end of the intake duct 22.

As illustrated in the drawing, in the cooling structure 40 of this embodiment, the duct fixing part 43 is disposed on an upper surface of the top plate 21A of the battery case 21. The duct fixing part 43 is made of the same metal member as the battery case 21 and is fixed to the top plate 21A in the vicinity of the intake port 21B by screws or the like. The duct fixing part 43 opens and straightly extends toward a rear side of the vehicle 12 along the top plate 21A and has a space for fixing the intake duct 22, over the top plate 21A.

The intake duct 22 has a straight shape and is inserted in the inside of the duct fixing part 43, at a downstream part, to be fixed to the battery case 21. An upstream part of the intake duct 22 is disposed so as to slightly project from the duct fixing part 43. In response to operation of the blower 23 that is disposed in the inner duct 42, air in a vehicle cabin is sucked into the intake duct 22. As described above, this air is, for example, air that is cooled by air conditioning equipment in the vehicle cabin and outside air. This air is sent to the high-voltage unit, such as the battery modules 20, and it is used as cooling air.

The inner duct 42 is, for example, routed toward a front side of the vehicle 12 and then toward the bottom plate 21C, in the battery case 21. Cooling air is supplied from the inner duct 42 to the battery modules 20, on a bottom plate 21C side of the battery case 21.

FIG. 5A illustrates an exemplary case in which pole impact occurs due to a pole colliding from a center part on a rear side of the vehicle 12, and a barrier 31 invades the inside of the vehicle 12 and passes over the upper surface of the top plate 21A of the battery case 21.

As illustrated in the drawing, when the barrier 31 that invades the inside of the vehicle 12 passes over the upper surface of the top plate 21A of the battery case 21, the barrier 31 first crashes into the upstream end of the intake duct 22. The intake duct 22 that is crashed by the barrier 31 is pressed to an upstream end of the duct fixing part 43 and is compressed and deformed between the barrier 31 and the duct fixing part 43.

The barrier 31 continues advancing to the inside of the vehicle 12 and then also crashes into the upstream end of the duct fixing part 43. Due to a one-side fixed structure in which an end of the duct fixing part 43 is fixed on the top plate 21A of the battery case 21, as described above, the duct fixing part 43 is turned up toward the front side of the vehicle 12 while being deformed by crash with the barrier 31.

FIG. 5A illustrates a situation in which the barrier 31 passes the fixed part of the duct fixing part 43, on the top plate 21A, and it continues advancing toward the inside of the vehicle 12. The duct fixing part 43 is fixed on the top plate 21A in the vicinity of the intake port 21B. Thus, due to invasion of the barrier 31, the fixed part of the duct fixing part 43 comes off from the top plate 21A, and the duct fixing part 43 is separated from the top plate 21A.

The intake duct 22, which is inserted and is fixed in the duct fixing part 43, as described above, is also separated from the battery case 21 together with the duct fixing part 43. As a result, the intake duct 22 and the duct fixing part 43 are removed from above the top plate 21A of the battery case 21, and the intake port 21B is exposed.

However, in the cooling structure 40 of this embodiment, the inner duct 42 is disposed in the battery case 21. The inner duct 42 is not directly coupled to the intake duct 22, and it still remains at its initially assembled position although the intake duct 22 is removed by the barrier 31.

In this structure, the intake port 21B is covered with the inner duct 42 as seen from the inside of the battery case 21. Although disposed in the vicinity of the intake port 21B of the battery case 21, the high-voltage unit, such as the electrodes of the battery modules 20 and the bus bar, is prevented from being exposed at the intake port 21B. Thus, the possibility for occupants in the vehicle and rescuers to touch the high-voltage unit is reduced.

The cooling structures 10 and 40 of the embodiments are described by referring to the case in which the barrier 31 invades the housing space 13 under the rear floor of the vehicle 12 in response to poll impact occurring from a rear side of the vehicle 12. However, other situations can also be presumed. In one example, the cooling structure 10 or 40 of the battery pack 11 may be disposed in a housing space under the front floor, and side impact may occur from a side of the vehicle 12. Also in this case, effects that are the same as or similar to those described above are obtained. In the case of side impact, a side sill or the like of the vehicle 12 may be damaged and may invade the inside of the vehicle 12 as a barrier 31. Also in this case, the high-voltage unit in the battery case 21 is prevented from being exposed at the intake port 21B of the top plate 21A.

In addition, although the cooling structure 40 is described by referring to the case in which the duct fixing part 43 and the intake duct 22 extend toward the rear side of the vehicle 12, the structures are not limited thereto. Similarly, in a case in which the duct fixing part 43 and the intake duct 22 extend in the vehicle width direction or toward the front side of the vehicle 12, effects that are the same as or similar to those described above are obtained. When the duct fixing part 43 and the intake duct 22 are removed from the upper surface of the top plate 21A due to crash with the barrier 31, the inner duct 42 prevents the high-voltage unit from being exposed at the intake port 21B. Various other modifications and alterations can be made without departing from the gist of the disclosure.

In the cooling structure of the battery pack of the embodiment of the disclosure, the intake port is disposed in the top plate of the battery case, and the intake duct communicates with the battery case via the intake port. The intake duct is provided with the bent part that is bent toward the bottom plate of the battery case, in the vicinity of the end of the top plate. With this structure, when a collision accident of the vehicle occurs, and a barrier configured with a damaged part of the vehicle crashes into the intake duct, the bent part and its surrounding area of the intake duct are hung on the top plate, and the intake port still remains in a covered state. Thus, the high-voltage unit in the battery case is prevented from being exposed at the intake port, whereby the possibility for occupants and so on to touch the high-voltage unit is reduced.

1. A cooling structure of a battery pack, the cooling structure comprising:
a battery case housing a battery module and electronic equipment coupled to the battery module;
an intake duct communicating with the battery case, the intake duct being configured to send cooling air for cooling the battery module; and
an intake port disposed in a top plate of the battery case, the intake port being configured to send the cooling air into the battery case, wherein
the intake duct is coupled to the top plate so as to communicate with the battery case via the intake port and extends from the intake port to an end of the top plate,
the intake duct is provided with a bent part that is downwardly bent in a vicinity of the end of the top plate.

2. The cooling structure of the battery pack according to claim 1, wherein the battery case is housed in a housing space under a rear floor of a vehicle, and the bent part of the intake duct is disposed toward a rear side of the vehicle.

3. A cooling structure of a battery pack, the cooling structure comprising:
a battery case housing a battery module;
an intake duct communicating with the battery case, the intake duct being configured to send cooling air for cooling the battery module; and
an intake port disposed in a top plate of the battery case, wherein
the battery case comprises an inner duct that is configured to send the cooling air to the battery module,
the inner duct is coupled to the top plate from an inside of the battery case so as to communicate with the intake port,
the top plate has an upper surface provided with a duct fixing part that communicates with the inner duct via the intake port and that fixes the intake duct, and
the intake duct communicates with the inner duct via the duct fixing part.

4. The cooling structure of the battery pack according to claim 3, wherein
each of the battery case and the duct fixing part is made of a metal material, and
the duct fixing part is fixed to the top plate of the battery case.

5. The cooling structure of the battery pack according to claim 3, wherein
the battery case is housed in a housing space under a rear floor of a vehicle,
the duct fixing part opens toward a rear side of the vehicle, and
the intake duct extends toward the rear side of the vehicle, over the top plate.

6. The cooling structure of the battery pack according to claim 4, wherein
the battery case is housed in a housing space under a rear floor of a vehicle,
the duct fixing part opens toward a rear side of the vehicle, and
the intake duct extends toward the rear side of the vehicle, over the top plate.
